(19) United States
(12) Patent Application Publication
(10) Pub. No.: US 2019/0073658 A1
(43) Pub. Date: Mar. 7, 2019

(54) SALES DATA PROCESSING APPARATUS, METHOD FOR PROCESSING SALES DATA, AND RECORDING MEDIUM

(71) Applicant: CASIO COMPUTER CO., LTD., Tokyo (JP)

(72) Inventors: Taiki Murakami, Tokyo (JP); Kiyoshi Ogishima, Tokyo (JP); Yoshihiro Sato, Asaka-shi (JP)

(73) Assignee: CASIO COMPUTER CO., LTD., Tokyo (JP)

(21) Appl. No.: 16/100,710

(22) Filed: Aug. 10, 2018

(30) Foreign Application Priority Data
Sep. 1, 2017 (JP) 2017-168177
Dec. 22, 2017 (JP) 2017-246752

(51) Int. Cl. G06Q 20/20; G06K 19/06

(52) U.S. Cl. CPC G06Q 20/209; G06K 19/025; G06K 19/06037; G06Q 20/202

(57) ABSTRACT

A sales data processing apparatus includes a processor that functions as: a processing unit configured to perform accounting processing for a product having been subject to sales registration; and a control unit configured to cause a communication unit to transmit, when the accounting processing is performed by the processing unit, accounting data associated with the accounting processing while causing a printing unit to print the accounting data together with information indicating that the accounting data has been transmitted.

### BACKGROUND

### 1. Technical Field

The present invention relates to a sales data processing apparatus, a method for processing sales data, and a recording medium.

### 2. Related Art

It is known to print a receipt for a customer as a sales detailed statement when the customer makes payment at a shop or the like. Recently, it is also known to issue, instead of printing a receipt, an electronic receipt to a mobile terminal or the like carried by a customer. Furthermore, it is known to output both of those receipts as necessary.

Examples of such an invention includes the invention disclosed in JP 2004-151838 A. In the solution to problems described in the abstract in this literature, the following descriptions are disclosed. “A receipt issuing system according to the present invention is a receipt issuing system that issues a receipt at the time of accounting processing for a product purchased by a customer in which an information setting device 16 sets, under control of a CPU 11, a necessity of each of electronic receipt issuing processing and receipt printing processing as a method for issuing a receipt by an input operation by the customer. Then, when execution of the electronic receipt issuing processing is set by the information setting device 16, the CPU 11 generates electronic receipt information based on the accounting processing, and notifies the customer of the electronic receipt information using a predetermined method. On the other hand, when execution of the receipt printing processing is set by the information setting device 16, in a receipt printer 17 under the control of the CPU 11, receipt printing information based on the accounting processing is generated, and the receipt printing information is printed out.”

However, according to the invention disclosed in this literature, an electronic receipt and a paper receipt exist simultaneously, whereby a function as a certificate is impaired and a meaning of a receipt in accounting processing is lost. Moreover, the receipt is used as a certificate of product purchase at the time of, for example, processing for returning the product, whereby a problem may be raised.

Furthermore, according to the invention disclosed in this literature, the customer cannot determine whether the electronic receipt has been simultaneously issued from the paper receipt. Accordingly, for example, there may raise a problem that the customer may computerize the information indicated in the paper receipt by him/herself using a method such as scanning despite the fact that the electronic receipt has been issued.

### SUMMARY

To solve the above problem, a sales data processing apparatus of the present invention includes a processor that functions as: a processing unit configured to perform accounting processing for a product having been subject to sales registration; and a control unit configured to cause a communication unit to transmit, when the accounting processing is performed by the processing unit, accounting data associated with the accounting processing while causing a printing unit to print the accounting data together with information indicating that the accounting data has been transmitted.

### BRIEF DESCRIPTION OF THE DRAWINGS

FIG. 1 is an external view illustrating an electronic cash register according to a first embodiment;

FIG. 2 is a block diagram illustrating an outline of the electronic cash register;

FIG. 3 is a view illustrating an arrangement of a keyboard of the electronic cash register;

FIG. 4 is a sequence diagram illustrating a series of operations from sales registration to receipt issuance;

FIG. 5 is a flowchart illustrating a sales registration process;

FIG. 6 is a view of a paper receipt when an electronic receipt is simultaneously issued;

FIG. 7 is a view of a paper receipt when a customer cannot be specified;

FIG. 8 is a view of a paper receipt when an electronic receipt is simultaneously issued according to a variation of the first embodiment;

FIG. 9 is an external view illustrating an electronic cash register according to a second embodiment;

FIG. 10 is a block diagram illustrating an outline of the electronic cash register according to the second embodiment;

FIG. 11 is a sequence diagram illustrating a series of operations from the sales registration and the receipt issuance to household accounts registration;

FIG. 12 is another flowchart illustrating the sales registration process;

FIG. 13 is another view of the paper receipt when the electronic receipt is simultaneously issued;

FIG. 14 is another view of the paper receipt when the customer cannot be specified; and

FIG. 15 is a view of a paper receipt when an electronic receipt is simultaneously issued according to a variation of the second embodiment.

### DETAILED DESCRIPTION

Hereinafter, embodiments of the present invention will be described in detail with reference to the respective drawings.

An electronic cash register is a device to which each sales amount of a shop is input, which registers a series of sales and issue a receipt. The electronic cash register according to the present embodiment specifies a customer at the time of sales registration, and makes a store clerk (operator) choose what to output from among an electronic receipt, a paper receipt, or both. When both the electronic receipt and the paper receipt are chosen by the store clerk, the electronic cash register outputs the paper receipt with information indicating that “the electronic receipt has been issued” added thereto. Accordingly, it can be easily determined whether the electronic receipt has been issued by simply checking the paper receipt.

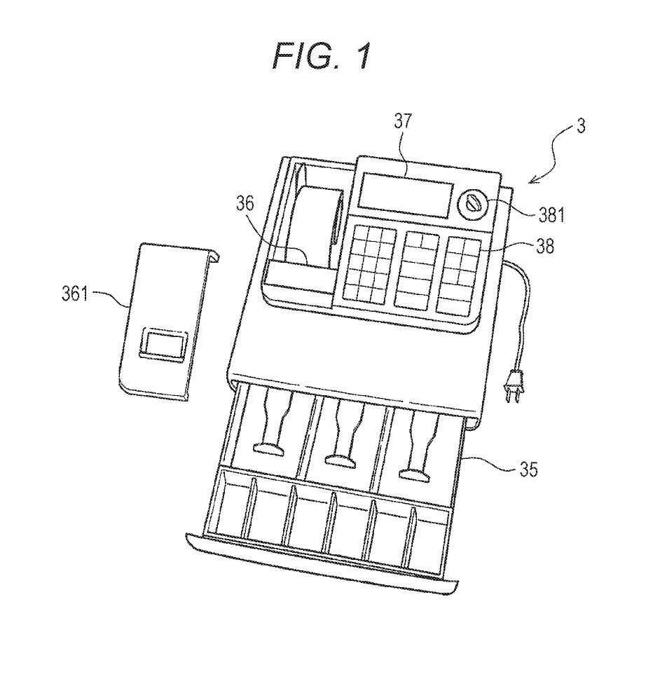

FIG. 1 is an external view illustrating an electronic cash register 3 according to a first embodiment.

The electronic cash register 3 is configured by disposing a casing on a drawer 35. The drawer 35 can be disposed separately from the casing of the electronic cash register 3.

A printing unit 36 is disposed on the left side of the casing, and on the right side thereof, a keyboard 38, a display unit 37, and a mode switch 381 are disposed. Note that, although a printer cover 361 is normally fitted in a position covering the printing unit 36, it is removed in FIG. 1 to illustrate the printing unit 36.

The operator (store clerk) of the electronic cash register 3 can register a product by inputting a department and a unit price of the product via the keyboard 38, displaying a subtotal, and then inputting a deposit. The electronic cash register 3 causes the drawer 35 to be pulled out and have the deposit deposited therein.

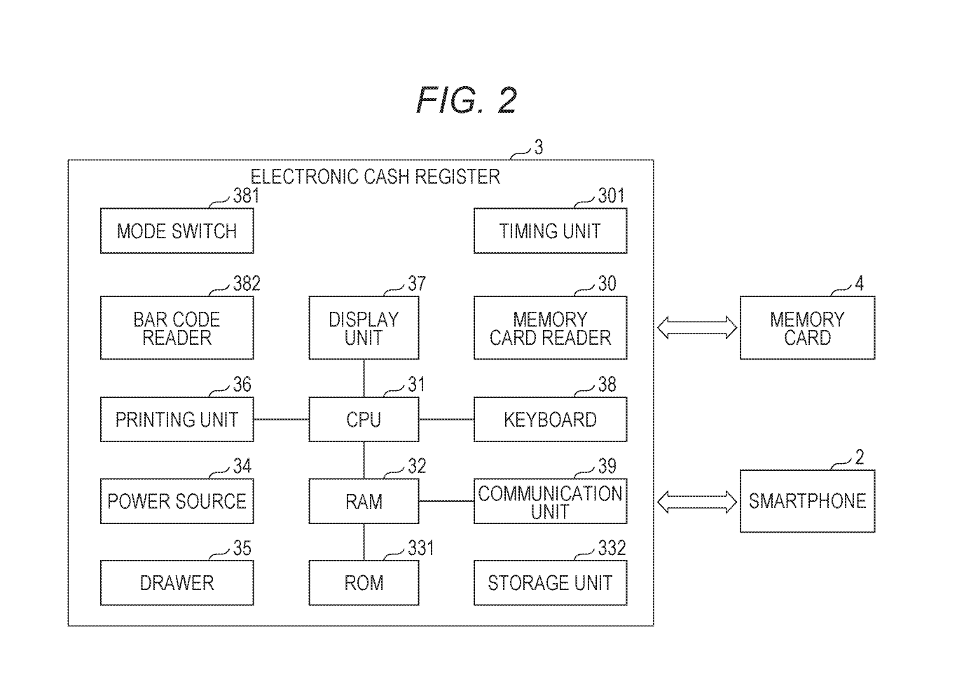

FIG. 2 is a block diagram illustrating an outline of the electronic cash register.

The electronic cash register 3 includes a central processing unit (CPU) 31, a random access memory (RAM) 32, a read only memory (ROM) 331, a storage unit 332, a power source 34, the drawer 35, the printing unit 36, the display unit 37, the keyboard 38, a communication unit 39, a memory card reader 30, and a timing unit 301. The respective units are connected by a bus. The electronic cash register 3 further includes the mode switch 381 and a bar code reader 382. Note that the mode switch 381 may be referred to as “mode SW” in the drawings.

The CPU 31 (processing unit, control unit, specifying unit, and selecting unit) expands, in a work memory in the RAM 32, an application program specified from among various application programs supporting the electronic cash register 3 stored in the ROM 331, the storage unit 332, or the like as well as various instructions input from the keyboard 38. The CPU 31 further executes various processing in accordance with the application program expanded in the work memory corresponding to the input instruction and the input data, stores the processing result in the work memory in the RAM 32, and displays the processing result on the display unit 37. Then, the CPU 31 saves the processing result stored in the work memory in a saving destination in the RAM 32 instructed from the keyboard 38. The CPU 31 functions as a printing control unit that causes the printing unit 36 to print accounting data together with information indicating that the accounting data has been transmitted to an external device.

The timing unit 301 clocks the date and time. The date and time clocked by the timing unit 301 are used for printing on a receipt, for example.

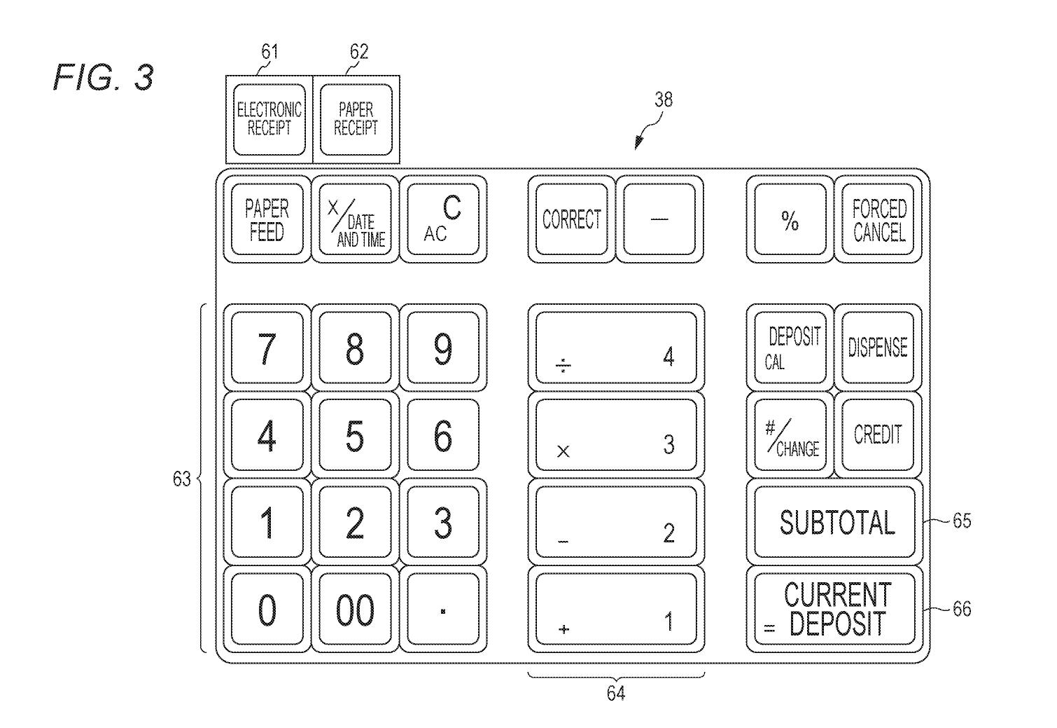

The keyboard 38 includes various function keys including, for example, a department key, a current/deposit key, and a clear key, a numeric input key, and the like, and outputs a depression signal pressed by each key to the CPU 31. The keyboard 38 will be described in detail later with reference to FIG. 3.

Note that the keyboard 38 is not limited to the keyboard 38, and any device may be used as long as input instructions can be made therewith. Instead of the keyboard 38, a touch panel (touch screen) and the like may be used in such a manner that coordinates instructed using an input pen, a fingertip, or the like are sensed and instructed position coordinates are detected using a coordinate reading principle such as an electromagnetic induction type, a magnetostrictive type, and a pressure sensitive type.

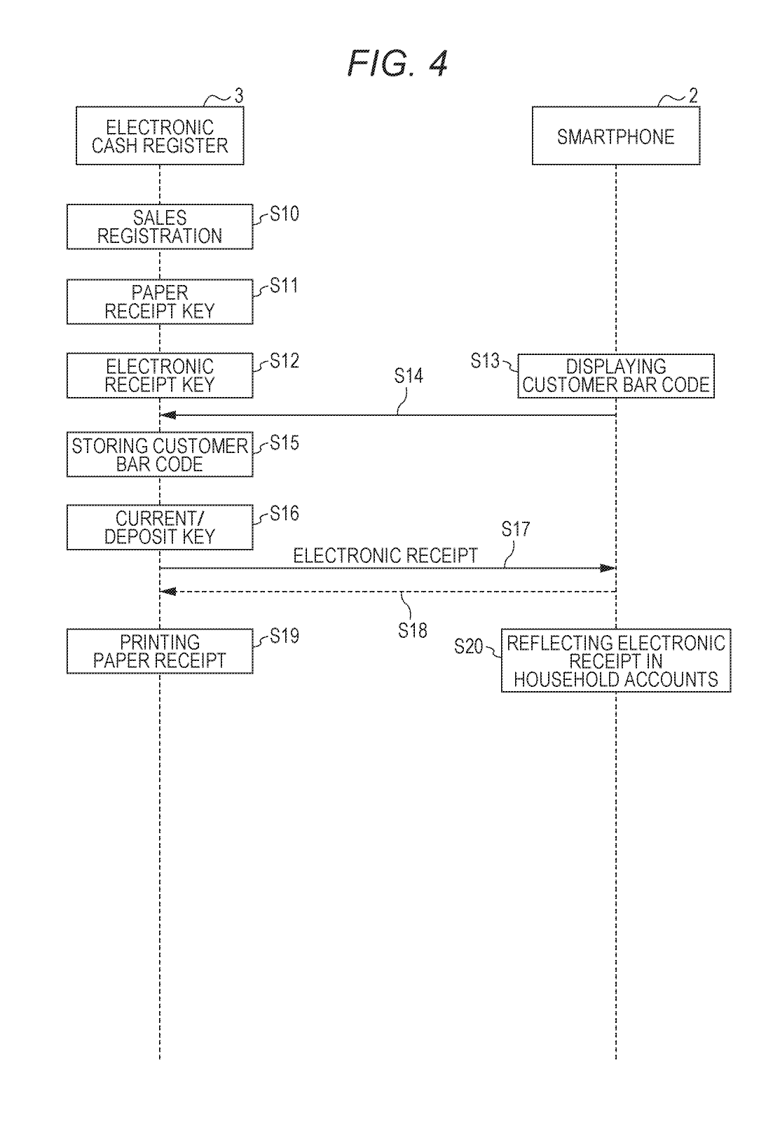

The mode switch 381 is a switch that determines an operation mode of the electronic cash register 3, which will be described in detail later with reference to FIG. 4.

The power source 34 is, for example, a DC power circuit that converts commercial AC power into DC power, and supplies the DC power to each unit of the electronic cash register 3.

The drawer 35 is a storage unit for storing cash such as coins and paper notes. The drawer 35 is unlocked and locked by the operation of the electronic cash register 3.

The display unit 37 according to the first embodiment includes, for example, a seven-segment liquid crystal display or a light-emitting element, and supports a numeral and a simple alphabetical display. The electronic cash register 3 generates a signal based on display data input from the CPU 31, and performs various displays on the display unit 37.

The printing unit 36 is, for example, a thermal transfer printer, and outputs receipt information by printing the receipt information on roll paper (receipt paper) in accordance with an instruction from the CPU 31.

The storage unit 332 includes a magnetic or optical storage medium, or a rewritable storage medium such as a semiconductor memory. The storage unit 332 stores a system program, various application programs corresponding to the system, data processed by these programs, and the like.

The communication unit 39 is, for example, a communication unit supporting Bluetooth (registered trademark) low energy (hereinafter referred to as BLE) and the like, and is capable of mutually communicating with a smartphone 2. When the customer is specified, the communication unit 39 functions as a communication unit for transmitting accounting data relating to the customer to the smartphone 2.

The CPU 31 of the electronic cash register 3 transmits the electronic receipt to an information terminal such as the smartphone 2, and when outputting the receipt information by printing the receipt information on the roll paper (receipt paper) using the printing unit 36, the paper receipt to which the information indicating that “the electronic receipt has been issued” is added is output. Accordingly, the customer of the shop can determine whether the electronic receipt has been simultaneously issued by simply viewing the paper receipt.

A memory card 4 can be inserted/removed into/from the memory card reader 30, and the memory card reader 30 can read/write a desired file from/to the memory card 4. The memory card reader 30 is a storage control unit for storing sales data in the memory card 4 (external storage medium).

The bar code reader 382 optically reads a two-dimensional bar code and obtains encoded information. The two-dimensional bar code is printed on a membership card of the customer, or displayed on a screen (not illustrated) of the application only available to members on the smartphone 2. The bar code reader 382 functions as a specifying unit for specifying the customer by optically reading code information indicating the customer from the two-dimensional bar code.

A part of or all of the programs, data, and the like to be stored in the storage unit 332 may be received from another device such as a server and a client via a transmission medium such as a network line and stored in the storage unit 332. Further, the storage unit 332 may be a recording medium of a server constructed on a network. Furthermore, each program may be transmitted to the server or the client via the transmission medium such as the network line and installed in those devices.

FIG. 3 is a view illustrating an arrangement of the keyboard 38 of the electronic cash register 3.

The keyboard 38 includes an electronic receipt key 61, a paper receipt key 62, a numerical pad 63, a department key 64, a subtotal key 65, a current/deposit key 66, and the like. Among those keys, a light emitting diode (LED) element is incorporated in the electronic receipt key 61 and the paper receipt key 62 so that states thereof are indicated by turning on/off the light.

The electronic receipt key 61 is a toggle key that switches whether or not to issue the electronic receipt. When the electronic receipt is issued, the LED element of the electronic receipt key 61 is controlled to light up. When the electronic receipt is not issued, the LED element of the electronic receipt key 61 is controlled to turn off the light.

The paper receipt key 62 is a toggle key that switches whether or not to output (issue) the paper receipt. When the paper receipt is output (issued), the LED element of the paper receipt key 62 is controlled to light up. When the paper receipt is not output (issued), the LED element of the paper receipt key 62 is controlled to turn off the light.

In the initial state, the electronic receipt key 61 is turned off, and the paper receipt key 62 lights up. When the store clerk completes the sales registration at this time, only the paper receipt is issued.

When the electronic receipt key 61 is pressed in the initial state, the electronic receipt key 61 lights up by the toggle operation, and both the paper receipt and the electronic receipt are issued.

Similarly, when the paper receipt key 62 is pressed in the initial state, the paper receipt key 62 turns off the light by the toggle operation. At this time, the electronic receipt key 61 lights up so that only the electronic receipt is issued, thereby preventing a state in which both the paper receipt and the electronic receipt are not issued.

Besides, when the electronic receipt key 61 is pressed while only the electronic receipt key 61 lights up, the electronic receipt key 61 turns off the light by the toggle operation. At this time, the paper receipt key 62 lights up so that only the paper receipt is issued, thereby preventing the state in which both the paper receipt and the electronic receipt are not issued.

The numerical pad 63 is keys to be pressed at the time of entering numbers. The department key 64 is a key to be pressed at the time of registering individual product.

The subtotal key 65 is a key to be pressed at the time of checking the total of the registered amounts. The current/deposit key 66 is a key to be pressed at the time of completing the registration and receiving the deposit.

FIG. 4 is a sequence diagram illustrating a series of operations from the sales registration to the receipt issuance.

The sequence diagram in FIG. 4 starts when the customer of the shop shows a purchasing intention to the store clerk. Note that the case where both the paper receipt and the electronic receipt are issued will be described with reference to FIG. 4.

The store clerk performs sales registration on the electronic cash register 3 (step S10), and chooses whether or not the issuance of the paper receipt is required (step S11) by pressing the paper receipt key 62. Further, it is chosen whether or not the issuance of the electronic receipt is required (step S12) by pressing the electronic receipt key 61. When the issuance of the electronic receipt is required, the store clerk asks the customer to present customer identification information. The customer displays a bar code including the customer identification information on a display unit of the smartphone 2 (step S13). This customer identification information is information that specifies the smartphone of the customer. The electronic receipt can be transmitted to the smartphone of the customer by reading the customer identification information.

The store clerk reads the bar code using the bar code reader 382 (step S14), and stores the customer identification information read from the bar code (step S15).

Here, the smartphone 2 displays the bar code including the customer identification information on the display unit, and enters a state waiting for the electronic receipt reception.

Then, as the sales registration has been completed, the store clerk presses the current/deposit key 66. Accordingly, the electronic cash register 3 specifies the smartphone 2 of the customer on the basis of the stored customer identification information, and transmits the electronic receipt to the specified smartphone 2 (step S17). Here, a method for specifying the smartphone 2 of the customer corresponding to the read customer identification information is not particularly limited. For example, there is a method for specifying the smartphone 2 of the customer that refers to the registration information in which the customer identification information and the smartphone 2 of the customer are associated with each other and registered in advance. The smartphone 2 responds to the electronic cash register 3 that the electronic receipt has been received (step S18).

Then, the electronic cash register 3 prints the paper receipt (step S19). The smartphone 2 reflects the electronic receipt received in step S17 in household accounts (not illustrated) (step S20).

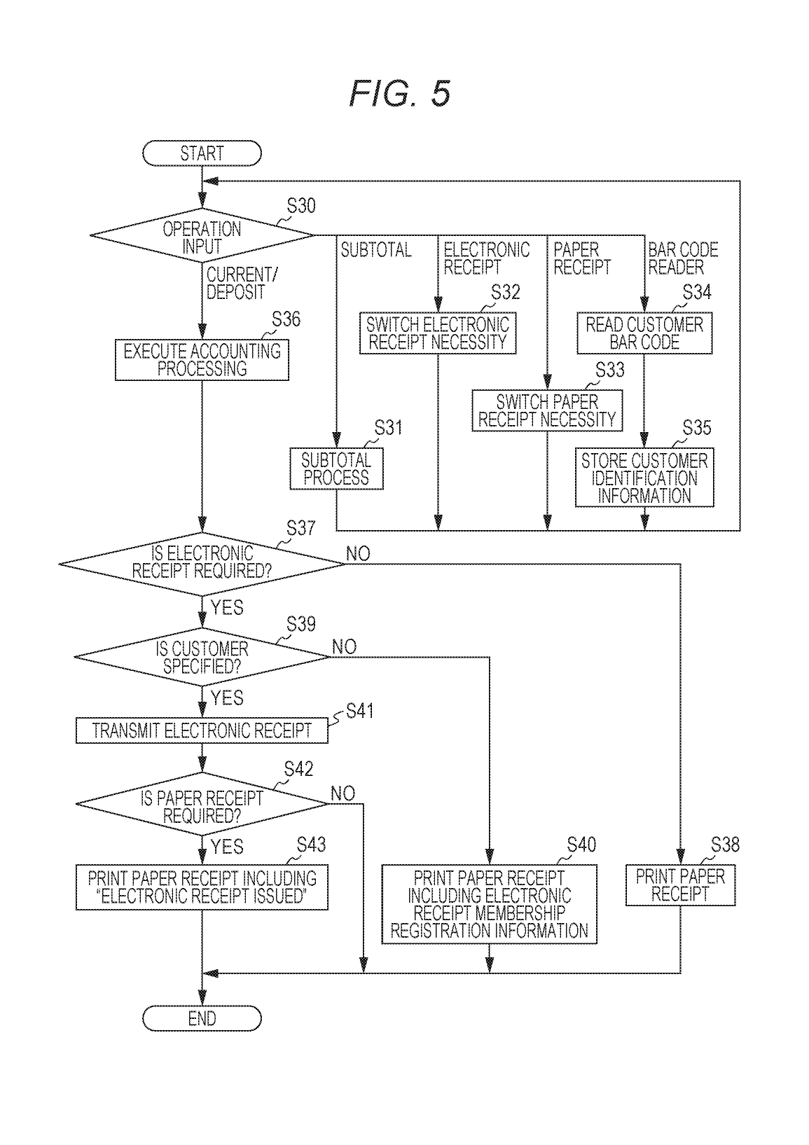

FIG. 5 is a flowchart illustrating the sales registration process. This sales registration process is executed in step S10 in FIG. 4.

The sales registration process in FIG. 5 starts when the customer of the shop shows a purchasing intention to the store clerk.

The CPU 31 determines whether an operation input from the store clerk as an operator has been received (step S30). In step S30, when the subtotal key 65 is pressed, the CPU 31 executes subtotal processing (step S31), and returns to the processing in step S30.

In step S30, when the electronic receipt key 61 is pressed by the store clerk, the CPU 31 switches the necessity of issuance of the electronic receipt (step S32), and returns to the processing in step S30. That is, in a case where the electronic receipt key 61 is in the lighting state, the LED element is turned off by the electronic receipt key 61 being pressed. In a case where the electronic receipt key 61 is in the off state, the LED element is turned on by the electronic receipt key 61 being pressed.

In step S30, when the paper receipt key 62 is pressed by the store clerk, the CPU 31 switches the necessity of issuance or output of the paper receipt (step S33), and returns to the processing in step S30. That is, in a case where the paper receipt key 62 is in the lighting state, the LED element is turned off by the paper receipt key 62 being pressed. In a case where the paper receipt key 62 is in the off state, the LED element is turned on by the paper receipt key 62 being pressed.

In step S30, when the bar code of the customer is read by the bar code reader 382 (step S34), the CPU 31 stores the customer identification information included in the bar code (step S35), and returns to the processing in step S30.

In step S30, when the current/deposit key 66 is pressed by the store clerk, the CPU 31 performs the accounting processing (step S36), and proceeds to the receipt issuance in step S37 and subsequent steps. When the paper receipt key 62 is in the lighting state and the electronic receipt key 61 is in the off state so that the issuance of the electronic receipt is not required (No in step S37), the CPU 31 prints the paper receipt (step S38), and the process in FIG. 5 terminates.

When the electronic receipt key 61 is in the lighting state so that the issuance of the electronic receipt is required (Yes in step S37), the CPU 31 determines whether the customer is specified (step S39). Specifically, it is determined whether the customer can be determined on the basis of the customer identification information stored in step S35. When the customer cannot be specified (No in step S39), the CPU 31 prints the paper receipt including the electronic receipt membership registration information (step S40), and the process in FIG. 5 terminates. An example of the paper receipt printed in step S40 is illustrated in FIG. 7 to be described later.

Note that the case where the customer cannot be specified in step S39 includes a case where the customer identification information is not stored in step S35. With the use of the paper receipt including the electronic receipt membership registration information, the store clerk can easily urge the customer to apply for the membership registration. For example, in a case where the customer who is not an electronic receipt member wants the electronic receipt to be issued, the store clerk proceeds to the accounting processing without reading the bar code in step S34 while turning the electronic receipt key 61 to the lighting state, whereby the paper receipt including the electronic receipt membership registration information can be printed in step S40.

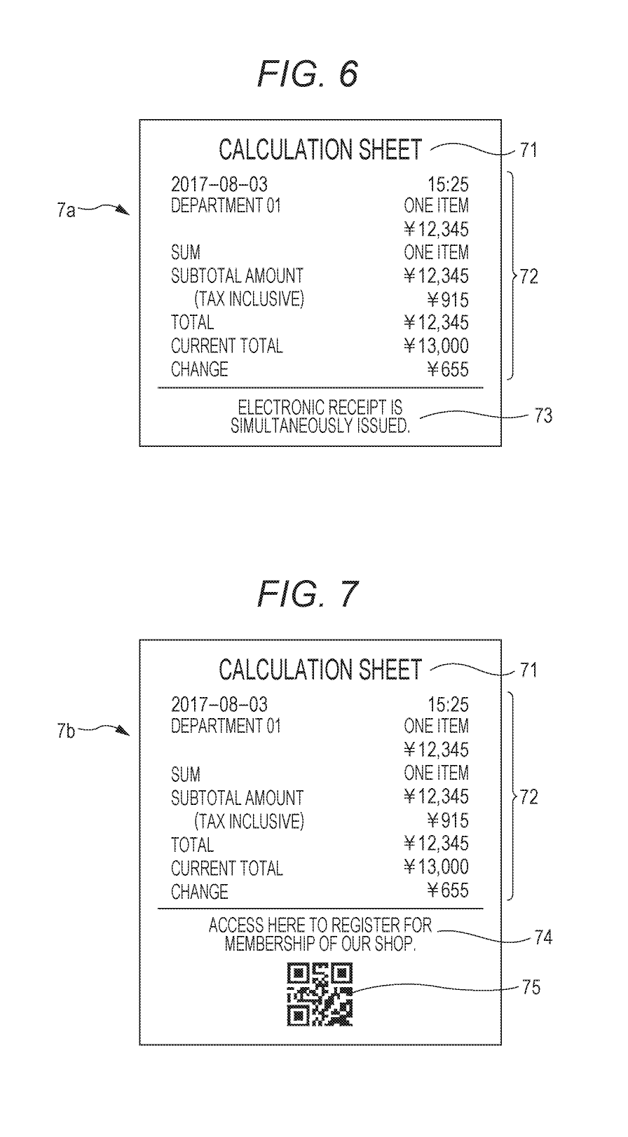

The CPU 31 stores the customer identification information through the processing in steps S34 and S35. When the customer is specified (Yes in step S39), the CPU 31 specifies the smartphone 2 of the customer on the basis of the stored customer identification information, and transmits the electronic receipt to the specified smartphone 2 (step S41). Further, the CPU 31 determines whether the output of the paper receipt is required (step S42). When the output of the paper receipt is required (Yes in step S42), the CPU 31 causes the printing unit 36 to print the paper receipt including the information indicating that “the electronic receipt has been issued” (step S43), and the process in FIG. 5 terminates. An example of the paper receipt printed in step S43 is illustrated in FIG. 6 to be described later.

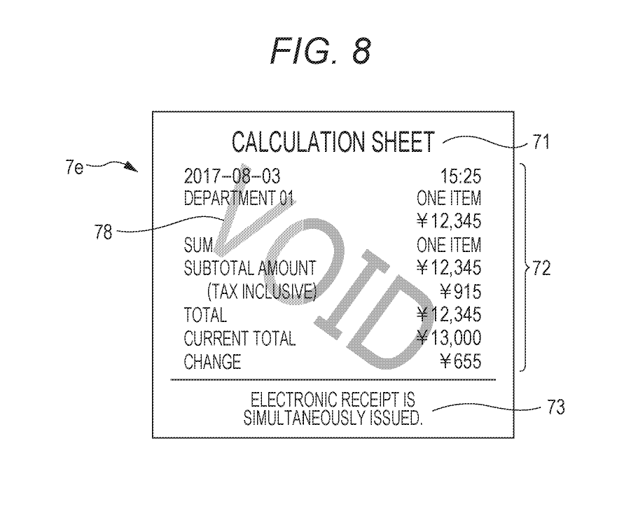

Note that an example of the paper receipt on which the accounting data, the information indicating that the accounting data has been transmitted, and a watermark indicating that the receipt cannot be treated as a valid receipt are printed in step S43 in a variation will be described later with reference to FIG. 8.

When the paper receipt key 62 is in the off state so that the output of the paper receipt is not required (No in step S42), the CPU 31 directly terminates the process in FIG. 5.

FIG. 6 is a view of a paper receipt 7a when the electronic receipt is simultaneously issued.

The paper receipt 7a is printed through the processing in step S43 in FIG. 5. The paper receipt 7a includes a title 71, a receipt area 72, and a comment area 73. The title 71 is printed as “calculation sheet”, and indicates the information printed on the paper receipt 7a. In the receipt area 72, a date and time, a department code, the number, a sum, a subtotal amount, tax included, a total, a current total, and change according to the receipt information are printed. Note that the date and time to be printed is obtained from the timing unit 301 (see FIG. 2).

Further, the comment area 73 is disposed on the lower side of the receipt area 72. In the comment area 73, the phrase “electronic receipt is simultaneously issued” is printed. Accordingly, the customer and the store clerk can easily determine that the paper receipt has been issued (output) concurrently with the electronic receipt.

FIG. 7 is a view of a paper receipt 7b when the customer cannot be specified.

The paper receipt 7b is printed through the processing in step S40 in FIG. 5. The processing in step S40 is executed when the electronic receipt is required while the customer cannot be specified. The electronic cash register 3 prints the membership registration information on the electronic receipt at this time considering that the timing is efficient to urge the customer to apply for the membership registration. The paper receipt 7b includes the title 71, the receipt area 72, a comment area 74, and a two-dimensional code area 75.

The title 71 and the receipt area 72 are similar to those of the paper receipt 7a illustrated in FIG. 6. In the comment area 74, the phrase “access here to register for membership of our shop” is printed, and a two-dimensional code is printed in the two-dimensional code area 75 below the comment area 74. In the two-dimensional code area 75, the two-dimensional code including link information of a web page for membership registration is printed. Accordingly, the customer can obtain the information regarding how to register for the membership of the shop.

In the first embodiment, the phrase “electronic receipt is simultaneously issued” is printed in the paper receipt 7a. Accordingly, a third party can determine that the paper receipt 7a cannot be used as a valid receipt. However, in case the printing area on which the phrase “electronic receipt is simultaneously issued” is printed has been torn out, the paper receipt 7a may be misused as a valid receipt. A variation of the first embodiment aims to prevent such a situation.

FIG. 8 is a view of a paper receipt 7e when an electronic receipt is simultaneously issued according to the variation of the first embodiment.

Similar to the paper receipt 7a illustrated in FIG. 6, the paper receipt 7e includes a title 71, a receipt area 72, and a comment area 73. Further, a watermark 78 is printed in light gray.

Here, the watermark 78 is printed as “VOID” in such a manner that the letters are slanted and overlaps the receipt area 72. That is, a CPU 31 (control unit) causes a printing unit to print, as information indicating that the paper receipt 7e cannot be treated as a valid receipt, the watermark 78 to overlap the receipt area (accounting data) 72. The watermark 78 also indicates that the paper receipt 7e cannot be treated as a valid receipt. Accordingly, the customer and the store clerk can easily determine that the paper receipt 7e has been issued (output) concurrently with the electronic receipt.

Besides, even when the comment area 73 of the paper receipt 7e has been torn out, the watermark 78 indicates that the paper receipt 7e cannot be treated as a valid receipt. The customer and the store clerk can easily determine that the paper receipt 7e has been issued (output) concurrently with the electronic receipt.

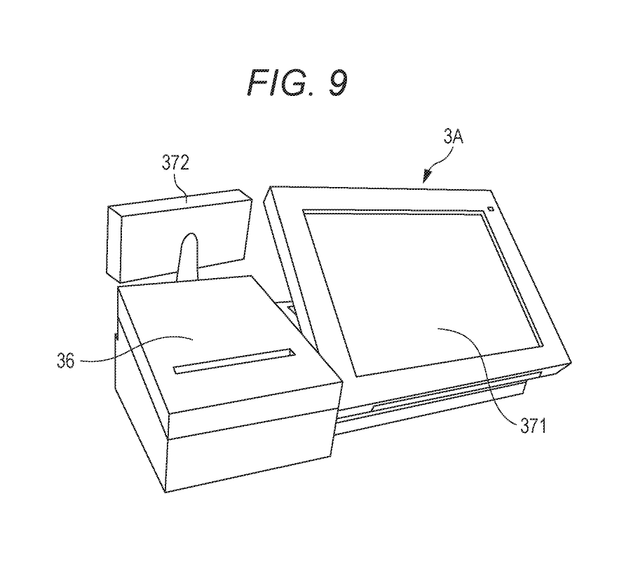

FIG. 9 is an external view of an electronic cash register 3A according to a second embodiment.

The electronic cash register 3A is configured separately from a drawer (not illustrated). The drawer can be electrically connected to the electronic cash register 3A.

A printing unit 36 and a customer display 372 are disposed on a left side of a casing, and a touch panel display 371 is disposed on the right side thereof.

An operator (store clerk) of the electronic cash register 3A can register a product by inputting a department and a unit price of the product via a software button on the touch panel display 371, displaying a subtotal, and then inputting a deposit. The electronic cash register 3A causes the drawer (not illustrated) to be pulled out and have the deposit deposited therein.

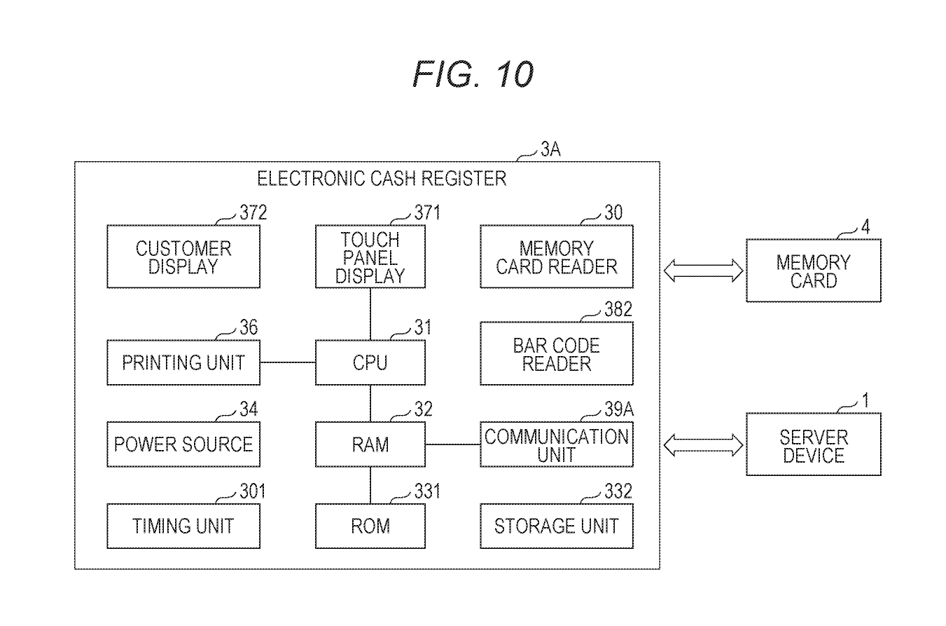

FIG. 10 is a block diagram illustrating an outline of the electronic cash register 3A according to the second embodiment.

The electronic cash register 3A includes a CPU 31, a RAM 32, a ROM 331, a storage unit 332, a power source 34, the printing unit 36, the touch panel display 371, the customer display 372, a bar code reader 382, a communication unit 39A, and a memory card reader 30. The respective units are connected by a bus. Unlike the first embodiment, the electronic cash register 3A does not include a mode switch.

The CPU 31 (processing unit, control unit, specifying unit, and selecting unit) expands, in a work memory in the RAM 32, an application program specified from among various application programs supporting the electronic cash register 3A stored in the ROM 331, the storage unit 332, or the like as well as various instructions input from the touch panel display 371. The CPU 31 further executes various processing in accordance with the application program expanded in the work memory corresponding to the input instruction and the input data, stores the processing result in the work memory in the RAM 32, and displays the processing result on the touch panel display 371. Then, the CPU 31 saves the processing result stored in the work memory in a saving destination in the RAM 32 instructed from the touch panel display 371.

The touch panel display 371 senses coordinates instructed using an input pen, a fingertip, or the like, detects instructed position coordinates using a coordinate reading principle such as an electromagnetic induction type, a magnetostrictive type, and a pressure sensitive type, and outputs a position signal to the CPU 31.

The power source 34 is, for example, a DC power circuit that converts commercial AC power into DC power, and supplies the DC power to each unit of the electronic cash register 3A.

The customer display 372 includes a liquid crystal display or an organic electro luminescence (EL) display, and supports a numeral, alphabetical, and drawings display. The electronic cash register 3A generates a signal based on display data input from the CPU 31, and performs various displays on the customer display 372.

The printing unit 36 is, for example, a thermal transfer printer, and outputs receipt information by printing the receipt information on roll paper (receipt paper). The printing unit 36 prints a settlement report or a checkout report on the receipt paper in accordance with an instruction from the CPU 31.

The storage unit 332 includes a magnetic or optical storage medium, or a rewritable storage medium such as a semiconductor memory. The storage unit 332 stores a system program, various application programs corresponding to the system, data processed by these programs, and the like.

The communication unit 39A is, for example, a communication unit supporting WiFi (registered trademark) and the like, and is capable of mutually communication with a server device 1 (see FIG. 10) via the Internet.

The CPU 31 of the electronic cash register 3A transmits the electronic receipt to the server device 1 using the communication unit 39A. The server device 1 accumulates the electronic receipts. Accordingly, a customer of a shop can refer to the electronic receipt later.

When the receipt information is output by printing the receipt information on the roll paper (receipt paper) using the printing unit 36, the CPU 31 outputs the paper receipt in such a manner that the information indicating that “the electronic receipt has been issued” and link information of the electronic receipt are added to the paper receipt. Accordingly, the customer of the shop can determine whether the electronic receipt has been simultaneously issued by simply viewing the paper receipt, and can easily obtain the electronic receipt corresponding to the paper receipt.

A memory card 4 can be inserted/removed into/from the memory card reader 30, and the memory card reader 30 can read/write a desired file from/to the memory card 4.

The bar code reader 382 optically reads a two-dimensional bar code and obtains encoded information. The two-dimensional bar code is printed on a membership card of the customer, or displayed on a screen of the application only available to members on a smartphone 2. The bar code reader 382 functions as a specifying unit for specifying the customer by optically reading code information indicating the customer from the two-dimensional bar code.

A part of or all of the programs, data, and the like to be stored in the storage unit 332 may be received from another device such as a server and a client via a transmission medium such as a network line and stored in the storage unit 332. Further, the storage unit 332 may be a recording medium of a server constructed on a network. Furthermore, each program may be transmitted to the server or the client via the transmission medium such as the network line and installed in those devices.

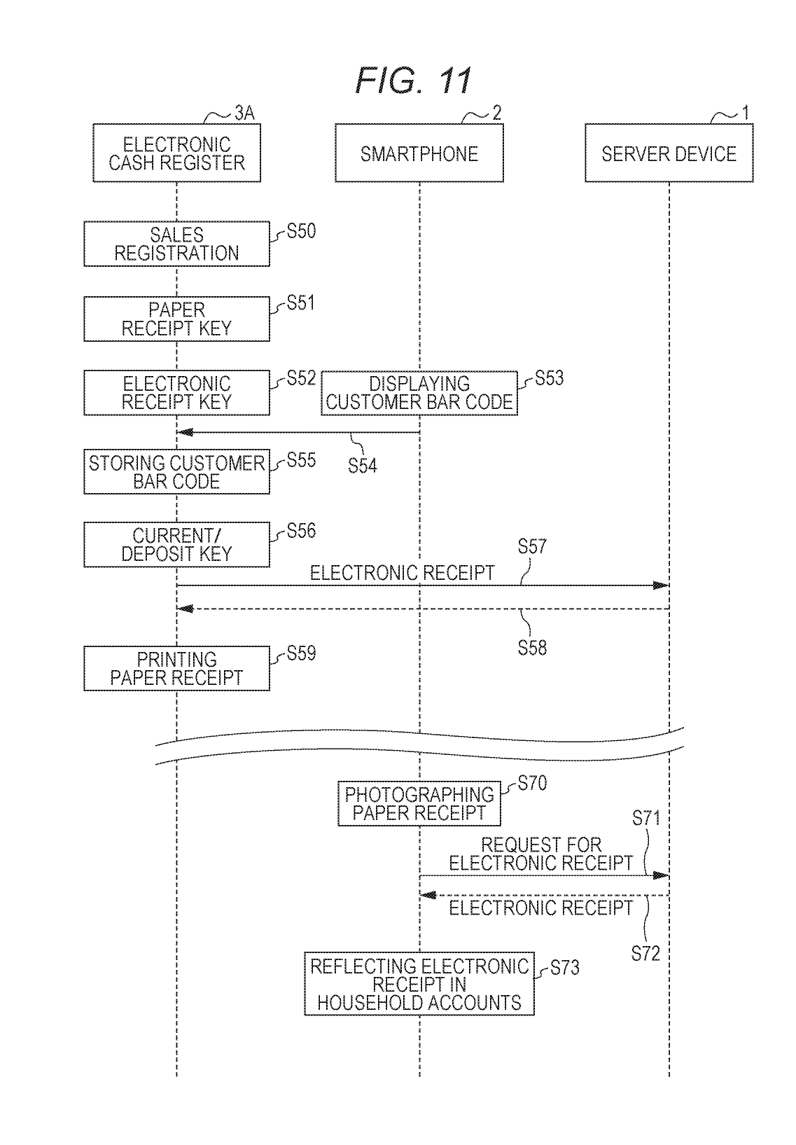

FIG. 11 is a sequence diagram illustrating a series of operations from the sales registration and the receipt issuance to household accounts registration.

The sequence diagram in FIG. 11 starts when the customer of the shop shows a purchasing intention to the store clerk.

The store clerk performs sales registration on the electronic cash register 3A (step S50), presses a paper receipt key on the touch panel display 371 (step S51), and presses an electronic receipt key (step S52). The store clerk asks the customer to present customer identification information while pressing the electronic receipt key. The customer displays a bar code including the customer identification information on a display unit of the smartphone 2 (step S53). The store clerk reads the bar code using the bar code reader 382 (step S54), and stores the information read from the bar code (step S55).

Then, as the sales registration has been completed, the store clerk presses a current/deposit key on the touch panel display 371. Accordingly, the electronic cash register 3A transmits the customer identification information and the electronic receipt to the server device 1 (step S57). The server device 1 responds to the electronic cash register 3A that the electronic receipt has been received (step S58). At this time, the server device 1 stores the electronic receipt on the basis of the customer identification information.

The electronic cash register 3A then prints the paper receipt including the link information of the electronic receipt (step S59).

Thereafter, the customer photographs the paper receipt using the smartphone 2 (step S70). The smartphone 2 obtains the link information of the electronic receipt, and requests the electronic receipt from the server device 1 on the basis of the link information of the electronic receipt and the customer identification information (step S71). The server device 1 responds to the smartphone 2 with the requested electronic receipt. In this manner, the smartphone 2 can easily obtain the electronic receipt. Since the electronic receipt can be obtained only by the combination of the link information of the electronic receipt and the customer identification information, even when another person has obtained the paper receipt, the person cannot obtain the electronic receipt.

The smartphone 2 reflects the electronic receipt in the household accounts (step S73), and the process in FIG. 11 terminates. In a case of recognizing data printed using optical character recognition (OCR) by photographing the paper receipt, a recognition error occurs at a predetermined ratio. On the other hand, with the method of obtaining the link information of the electronic receipt, accurate receipt information can be obtained.

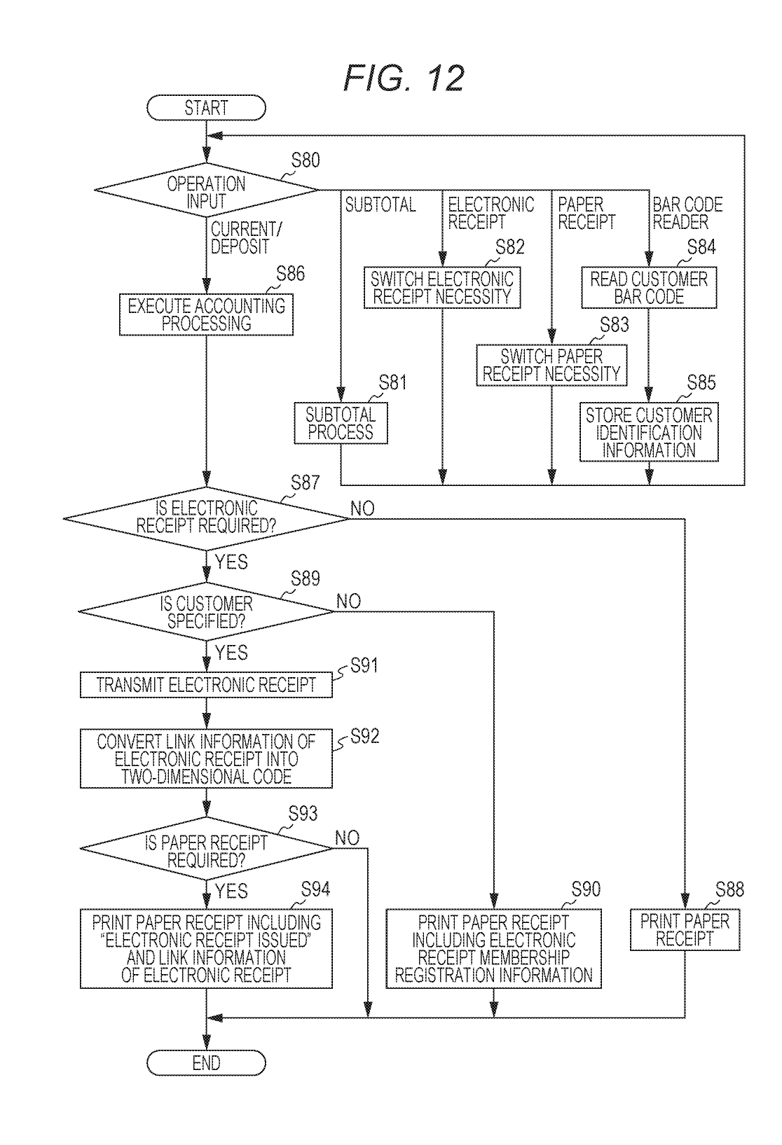

FIG. 12 is a flowchart illustrating the sales registration process.

The sales registration process in FIG. 12 starts when the customer of the shop shows a purchasing intention to the store clerk.

The CPU 31 determines whether an operation input from the store clerk as an operator has been received (step S80). In step S80, when a subtotal key on the touch panel display 371 is tapped, the CPU 31 executes subtotal processing (step S81), and returns to the processing in step S80.

In step S80, when the electronic receipt key on the touch panel display 371 is tapped by the store clerk, the CPU 31 switches the on/off state of the electronic receipt key (step S82), and returns to the processing in step S80.

In step S80, when the paper receipt key on the touch panel display 371 is tapped by the store clerk, the CPU 31 switches the on/off state of the paper receipt key (step S83), and returns to the processing in step S80.

In step S80, when the bar code of the customer is read by the bar code reader 382 (step S84), the CPU 31 stores the customer identification information included in the bar code (step S85), and returns to the processing in step S80.

In step S80, when the current/deposit key on the touch panel display 371 is tapped by the store clerk, the CPU 31 performs the accounting processing (step S86), and proceeds to the receipt issuance in step S87 and subsequent steps.

When the electronic receipt key is in the off state so that the issuance of the electronic receipt is not required (No in step S87), the CPU 31 prints the paper receipt (step S88), and the process in FIG. 12 terminates.

When the electronic receipt key is in the on state so that the issuance of the electronic receipt is required (Yes in step S87), the CPU 31 determines whether the customer is specified (step S89). Specifically, it is determined whether the customer can be determined on the basis of the customer identification information stored in step S85. When the customer cannot be specified (No in step S89), the CPU 31 prints the paper receipt including the electronic receipt membership registration information (step S90), and the process in FIG. 12 terminates. An example of the paper receipt printed in step S90 is illustrated in FIG. 14 to be described later.

Note that the case where the customer cannot be specified in step S89 includes a case where the customer identification information is not stored in step S85. With the use of the paper receipt including the electronic receipt membership registration information, the store clerk can easily urge the customer to apply for the membership registration. For example, in a case where the customer who is not an electronic receipt member wants the electronic receipt to be issued, the store clerk proceeds to the accounting processing without reading the bar code in step S84 while turning the electronic receipt key to the on state, whereby the paper receipt including the electronic receipt membership registration information can be printed in step S90.

The CPU 31 stores the customer identification information through the processing in steps S84 and S85. When the customer is specified (Yes in step S89), the CPU 31 transmits the customer identification information and the electronic receipt to the server device 1 (step S91), and converts the link information of the electronic receipt of the transmission destination into a two-dimensional code (step S92).

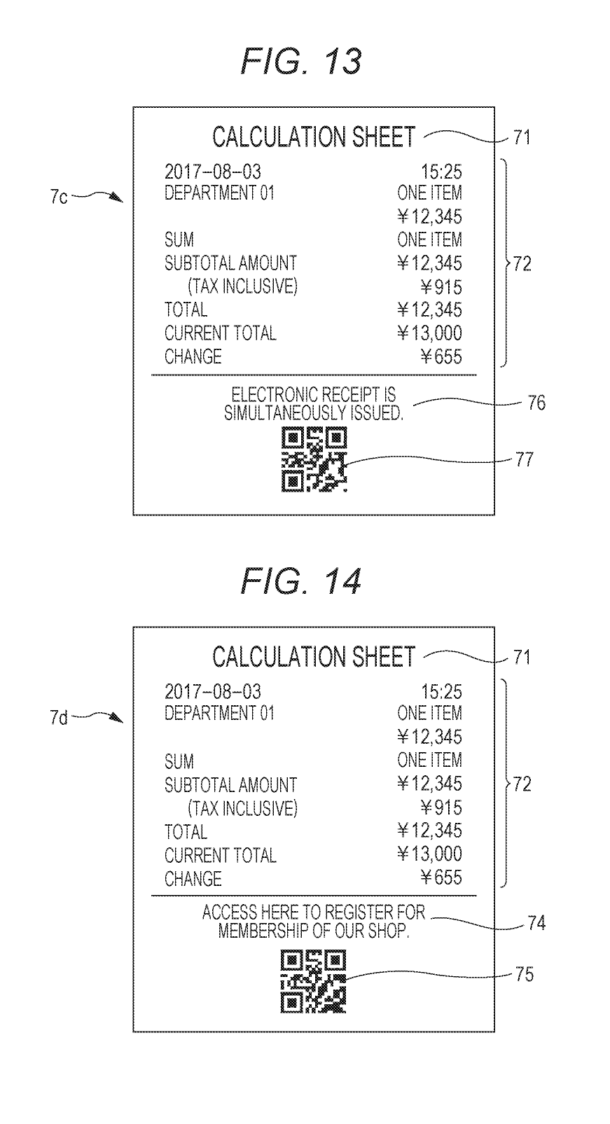

Further, the CPU 31 determines whether the paper receipt key is in the on state so that the output of the paper receipt is required (step S93). When the output of the paper receipt is required (Yes in step S93), the CPU 31 causes the printing unit 36 to print the paper receipt including the information indicating that “the electronic receipt has been issued” and the link information of the electronic receipt (step S94), and the process in FIG. 12 terminates. An example of the paper receipt printed in step S94 is illustrated in FIG. 13 to be described later.

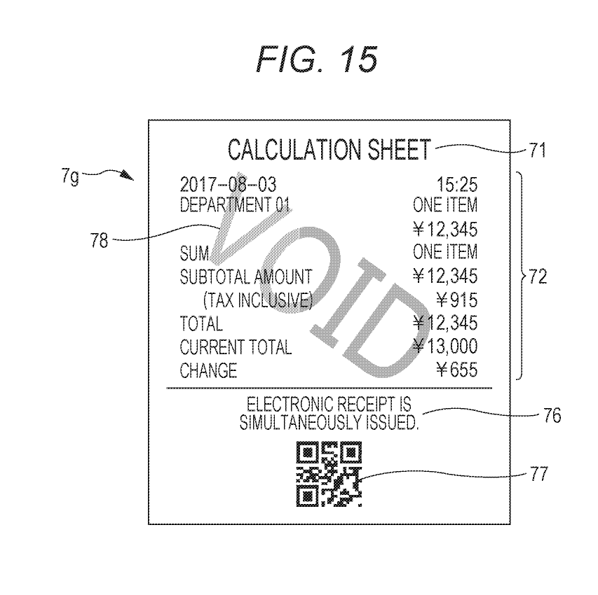

Note that an example of the paper receipt on which the link information of the accounting data, the accounting data, the information indicating that the accounting data has been transmitted, and a watermark indicating that the receipt cannot be treated as a valid receipt are printed in step S94 in a variation will be described later with reference to FIG. 15.

When the paper receipt key is in the off state so that the output of the paper receipt is not required (No in step S93), the CPU 31 directly terminates the process in FIG. 12.

FIG. 13 is a view of a paper receipt 7c when the electronic receipt is simultaneously issued.

The paper receipt 7c is printed through the processing in step S94 in FIG. 12. The paper receipt 7c includes the title 71, the receipt area 72, a comment area 76, and a two-dimensional code area 77.

The title 71 is printed as “calculation sheet”, and indicates the information printed on the paper receipt 7c. In the receipt area 72, a date and time, a department code, the number, a sum, a subtotal amount, tax included, a total, a current total, and change according to the receipt information are printed. Note that the date and time to be printed is obtained from the timing unit 301 (see FIG. 10).

Further, the comment area 76 and the two-dimensional code area 77 are disposed on the lower side of the receipt area 72. In the comment area 76, the phrase “electronic receipt is simultaneously issued” is printed. Accordingly, the customer and the store clerk can easily determine that the paper receipt 7c has been issued (output) concurrently with the electronic receipt. In the two-dimensional code area 77, the two-dimensional code including the link information of the electronic receipt corresponding to the receipt is printed. Accordingly, the customer can obtain the information relating to the electronic receipt, which corresponds to the paper receipt 7c.

FIG. 14 is a view of a paper receipt 7d when the customer cannot be specified.

The paper receipt 7d is printed through the processing in step S90 in FIG. 12. The paper receipt 7d is similar to the paper receipt 7b illustrated in FIG. 7.

In the second embodiment, the phrase “electronic receipt is simultaneously issued” is printed in the paper receipt 7c. Accordingly, a third party can determine that the paper receipt 7c cannot be used as a valid receipt. However, in case the printing area on which the phrase “electronic receipt is simultaneously issued” is printed has been torn out, the paper receipt 7c may be misused as a valid receipt. A variation of the second embodiment aims to prevent such a situation.

FIG. 15 is a view of a paper receipt 7f when an electronic receipt is simultaneously issued according to a variation of the second embodiment.

Similar to the paper receipt 7c illustrated in FIG. 13, the paper receipt 7f includes a title 71, a receipt area 72, a comment area 76, and a two-dimensional code area 77. Further, a watermark 78 is printed in light gray. Similar to the first embodiment illustrated in FIG. 8, the watermark 78 is printed as “VOID” in such a manner that the letters are slanted and overlaps the receipt area 72. That is, a CPU 31 (control unit) causes a printing unit to print, as information indicating that the paper receipt 7f cannot be treated as a valid receipt, the watermark 78 to overlap the receipt area (accounting data) 72. The watermark 78 also indicates that the paper receipt 7f cannot be treated as a valid receipt. Accordingly, the customer and the store clerk can easily determine that the paper receipt 7f has been issued (output) concurrently with the electronic receipt.

Besides, even when the comment area 76 of the paper receipt 7f has been torn out, the watermark 78 indicates that the paper receipt 7f cannot be treated as a valid receipt. The customer and the store clerk can easily determine that the paper receipt 7f has been issued (output) concurrently with the electronic receipt because of the watermark 78.

(Variations)

The present invention is not limited to the embodiments above, and may be modified without departing from the gist of the present invention as exemplified in the following (a) to (h).

(a) Link information of an electronic receipt to be printed on a paper receipt is not limited to a QR code (registered trademark) or a two-dimensional code, and may be an arbitrary code format.

(b) A case where electronic receipt membership registration information is printed on the paper receipt is not limited to a case where the electronic receipt is required while a customer is not specified, and the electronic receipt membership registration information may be printed when the electronic receipt is not required.

(c) Information to be encoded and printed on the paper receipt is not limited to the link information of the electronic receipt, and may be receipt information itself.

(d) A printing unit may not be incorporated in a casing of an electronic cash register, and a receipt may be printed using an external independent printing device.

(e) A phrase to be printed in a comment area of the paper receipt is not particularly limited as long as it indicates that the electronic receipt has been issued. Further, it is not limited to the phrase. A predetermined character, figure, symbol, or the like for indicating the issuance of the electronic receipt may be used.

(f) A watermark to be printed on the paper receipt is not limited to a letter string “VOID”. An arbitrary letter string, figure, symbol, or the like may be used as long as it is information indicating that the receipt cannot be treated as a valid receipt.

(g) An area in which the watermark is printed is not limited to a receipt area 72. As long as the watermark is printed to overlap at least the receipt area 72, the watermark may be printed to overlap other areas.

(h) Information indicating that the paper receipt cannot be treated as a valid receipt, which is printed on the paper receipt when the electronic receipt has been issued, is not limited to the watermark. The information indicating that the receipt cannot be treated as a valid receipt only needs to be inseparably printed on the receipt area 72. More specifically, letters “VOID” small in size may be repeatedly printed to surround the receipt area 72. Further, the letters “VOID” small in size may be horizontally printed at the right and left ends of the receipt area 72.

What is claimed is:

1. A sales data processing apparatus comprising a processor that functions as:
a processing unit configured to perform accounting processing for a product having been subject to sales registration; and
a control unit configured to cause a communication unit to transmit, when the accounting processing is performed by the processing unit, accounting data associated with the accounting processing while causing a printing unit to print the accounting data together with information indicating that the accounting data has been transmitted.

2. The sales data processing apparatus according to claim 1, wherein
the control unit is configured to cause the printing unit to print the accounting data, the information indicating that the accounting data has been transmitted, and information indicating that a receipt is not to be treated as a valid receipt.

3. The sales data processing apparatus according to claim 2, wherein
the control unit is configured to cause the printing unit to print a watermark as the information indicating that a receipt is not to be treated as a valid receipt in such a manner that the watermark overlaps the accounting data.

4. The sales data processing apparatus according to claim 1, wherein
the processor further functions as a specifying unit configured to specify a customer relating to the accounting processing, and
the control unit is configured to cause the communication unit to transmit the accounting data to a mobile terminal associated with the customer specified by the specifying unit.

5. The sales data processing apparatus according to claim 4, wherein
the specifying unit is configured to specify, when the accounting processing is performed, the customer relating to the accounting processing by optically reading code information for identifying each customer.

6. The sales data processing apparatus according to claim 1, wherein
the control unit is configured to cause the communication unit to transmit the accounting data to an external server device while causing the printing unit to print link information of the transmitted accounting data, the accounting data, and the information indicating that the accounting data has been transmitted.

7. The sales data processing apparatus according to claim 1, wherein
the processor further functions as a selecting unit configured to select one from among a first mode in which the communication unit is caused to transmit the accounting data and the printing unit is caused to print the accounting data, a second mode in which the communication unit is not caused to transmit the accounting data and the printing unit is caused to print the accounting data, and a third mode in which the printing unit is not caused to print the accounting data and the communication unit is caused to transmit the accounting data, and
the control unit is configured to cause, when the first mode is selected by the selecting unit, the printing unit to print the accounting data together with the information indicating that the accounting data has been transmitted.

8. The sales data processing apparatus according to claim 4, wherein
the processor further functions as a selecting unit configured to select one from among a first mode in which the communication unit is caused to transmit the accounting data and the printing unit is caused to print the accounting data, a second mode in which the communication unit is not caused to transmit the accounting data and the printing unit is caused to print the accounting data, and a third mode in which the printing unit is not caused to print the accounting data and the communication unit is caused to transmit the accounting data, and
the control unit is configured to cause, when the customer cannot be specified by the specifying unit while the first mode or the third mode is selected by the selecting unit, the printing unit to print information for registering customer information instead of the information indicating that the accounting data has been transmitted.

9. The sales data processing apparatus according to claim 7, further comprising:
a keyboard that receives an input operation from a user, wherein
the selecting unit selects a predetermined mode from a plurality of modes on the basis of the input operation via the keyboard.

10. The sales data processing apparatus according to claim 1, wherein
the control unit is configured to cause the printing unit to print the information indicating that the accounting data has been transmitted at a position close to a lower part of a printing medium.

11. The sales data processing apparatus according to claim 1, wherein
the control unit is configured to cause the printing unit to print the information indicating that the accounting data has been transmitted as a predetermined letter string.

12. The sales data processing apparatus according to claim 1, wherein
the control unit is configured to cause the printing unit to print a ruled line between the accounting data and the information indicating that the accounting data has been transmitted.

13. The sales data processing apparatus according to claim 1, wherein
the printing unit is a thermal transfer printer.

14. A method of processing information, comprising the steps of:
transmitting accounting data associated with accounting processing to a predetermined terminal device when the accounting processing for a product having been subject to sales registration is performed; and
printing the accounting data together with information indicating that the accounting data has been transmitted.

15. A non-transitory computer-readable recording medium storing a program for causing a computer to execute the steps of:
transmitting accounting data associated with accounting processing to a predetermined terminal device when the accounting processing for a product having been subject to sales registration is performed; and
printing the accounting data together with information indicating that the accounting data has been transmitted.
